(19) United States
(12) Patent Application Publication
(10) Pub. No.: US 2019/0342583 A1
(43) Pub. Date: Nov. 7, 2019

(54) SYSTEM AND METHOD FOR FACILITATING LIVE ONLINE EVENTS

(71) Applicant: MeetEm, Inc., Charleston, SC (US)

(72) Inventor: Howard Lee Gatch, III, Charleston, SC (US)

(21) Appl. No.: 16/401,959

(22) Filed: May 2, 2019

Related U.S. Application Data
(60) Provisional application No. 62/665,989, filed on May 2, 2018.

(51) Int. Cl. H04N 21/2187; G06Q 50/00; H04N 21/258; H04N 21/45; H04N 21/2668

(52) U.S. Cl. CPC H04N 21/2187; G06Q 50/01; H04N 21/2668; H04N 21/4532; H04N 21/25866

(57) ABSTRACT

A system and method for facilitating live events through an online platform and user management application. Embodiments of the present disclosure enable a platform and application for connecting celebrities and fans through an online community, and enabling celebrities to broadcast live online events and fans to view and participate in such events. System 100 is generally comprised of an event management application 102, a database 118, a payment gateway 112, one or more third party API's 114, a content delivery network 116, a communications network 122 a plurality of client devices 128, and a plurality of user profiles for fans 124 and celebrities 126.

### CROSS-REFERENCE TO RELATED APPLICATIONS

The present application claims the benefit of U.S. provisional application 62/665,989 filed May 2, 2018, the contents of which are hereby incorporated by reference herein in their entirety.

### FIELD

The present disclosure relates to the field of internet-enabled live events; in particular, a system and method for facilitating live events through an online platform and user management application.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An object of the present disclosure is a system for facilitating live online events comprising an event management application server being configured to execute instructions for a user management module, an event management module, and a plurality of application and business logic commands, the user management module operable to dynamically configure a plurality of fan user profiles and a plurality of celebrity user profiles, the event management module being operable dynamically configure a plurality of live online events; a database operably engaged with the event management application, the database being operable to store a plurality of event management and user management attributes; a video server operably engaged with the event management application; at least one celebrity client device operable to communicate one or more inputs to the event management application and broadcast a live online event; and, at least one fan client device operable to communicate one or more inputs to the event management application and view the live online event via a web or mobile browser.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The above and other objects, features and advantages of the present disclosure will be more apparent from the following detailed description taken in conjunction with the accompanying drawings, in which:

FIG. 1 is a functional block diagram of system for facilitating live online events, according to an embodiment of the present disclosure;

FIG. 2 is a process flow diagram of a routine for facilitating live online events, according to an embodiment of the present disclosure;

FIG. 3 is a process flow diagram of a routine for facilitating live online events, according to an embodiment of the present disclosure; and,

FIG. 4 is a process flow diagram of a routine for facilitating live online events, according to an embodiment of the present disclosure.

### DETAILED DESCRIPTION

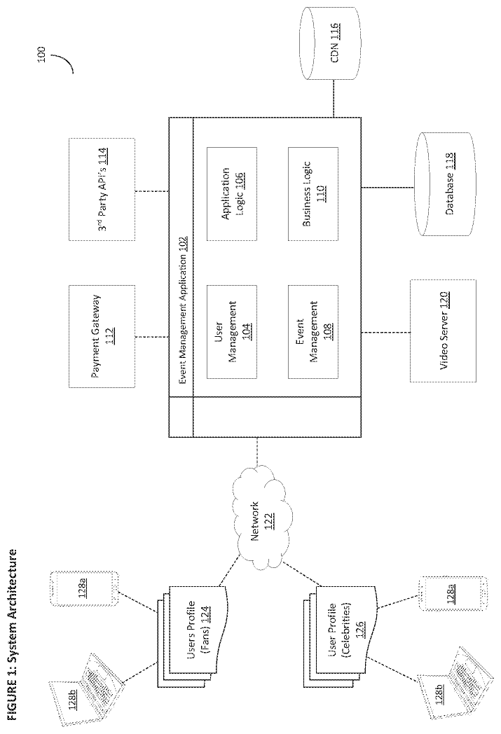

Referring now to FIG. 1, a functional block diagram of system 100 for facilitating live online events is shown. Embodiments of system 100 enable a platform and application for connecting celebrities and fans through an online community, and enabling celebrities to schedule and broadcast live online events and fans to view and participate in such events. According to an embodiment of the present disclosure, system 100 is generally comprised of an event management application 102, a database 118, a payment gateway 112, one or more third party API's 114, a content delivery network (CDN) 116, a communications network 122 a plurality of client devices 128, and a plurality of user profiles for fans 124 and celebrities 126. Event management application 102 is generally comprised of a user management module 104, application logic 106, event management module 108, and business logic 110. User management module 104 is operable to configure and manage a plurality of user profiles for fan users and celebrity users. Event management application 102 is operable to communicate a plurality of attributes for user profiles from user management module 104 to database 118; and, database 118 is operable to store and deliver the plurality of attributes for user management module 104. Event management module 108 is operable to configure a plurality of events associated with a plurality of celebrity user profiles 126 and manage a plurality of event reservations associated with a plurality of fan user profiles 124. Application logic 106 is operable to execute a plurality of commands to enable event management application 102 to be operably engage with payment gateway 112, third party API's 114, CDN 116, and video server 120. Business logic 110 is operable to execute one or more instructions to enable event user application 102 to manage and execute live online events over network 122 to the plurality of client devices 128a and 128b.

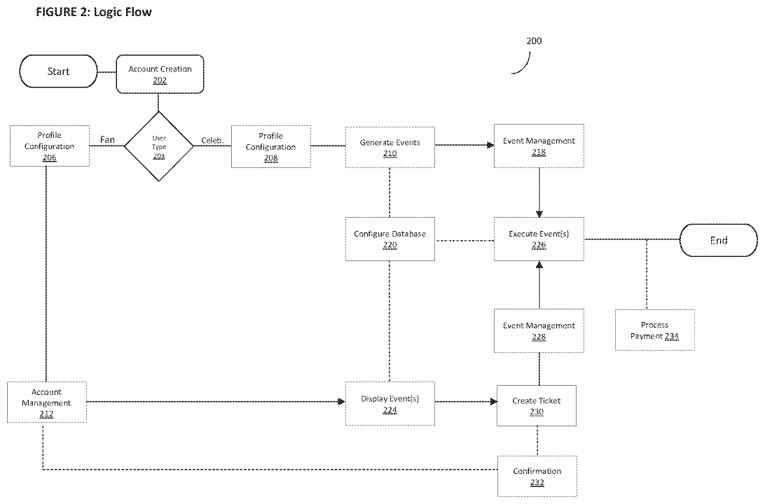

Referring now to FIG. 2, a process flow diagram of a routine 200 for facilitating live online events is shown. According to an embodiment of the present disclosure, a user creates an account 202 via a web or mobile interface. During account creation, the user selects a user type 204 for either a “Fan” user or “Celebrity” user. The terms “fan” and “celebrity” are used in a descriptive or illustrative context, and generally refer to a content consumer or viewer (fan) and a content creator or broadcaster (celebrity). If the user is a fan user, routine 200 proceeds with fan profile configuration 206. During fan profile creation 206, a fan user configures its fan profile to include account identification information and one or more celebrity users that the fan user wants to “like” or follow. If the fan user profile configures a multi-celebrity account, the fan user selects the number of celebrities associated with the multi-celebrity account selection; for example, four celebrities. Continuing with routine 200 from the perspective of the fan user, after profile configuration 206 routine 200 proceeds to account management 212. Account management 212 manages the fan user profile and makes recommendations of celebrity events based on profile configuration and usage statistics of the fan user. Routine 200 displays events 224 to the fan user profile so the fan user profile can view the events via a web or mobile browser to determine the number of events in which the fan user desires to participate.

Continuing with routine 200 from user type decision tree 204, if the user is a celebrity user then routine 200 proceeds with celebrity profile configuration 208. The celebrity user configures the celebrity user profile to include celebrity information and brand and/or copyright assets, types of events the celebrity user will broadcast, and pricing and scheduling information for such events. After inputting the event parameters, routine 200 proceeds with generating the event(s) 210. Once events are generated, the database is configured to store the event attributes 220. Event attributes from the database are displayed to fan users 224, as discussed above, such that users can view and select desired events in which to participate. Once a fan user selects a desired event, routine 200 creates a ticket 230 (i.e. a reservation) for the user to participate in such event at the scheduled date and time. The user receives an event confirmation 232 in the user's account and via email to confirm the user's participation in the event. If the user profile is configured as a multi-celebrity account, routine 200 associates the event confirmation with the event credits associated with the user's account.

Continuing with routine 200, after the celebrity user generates an event 210 and the fan user creates a ticket for an event 230, routine 200 executes an event management module for the celebrity user 218 and an event management module for the fan user 228. Event management 218 enables the celebrity user to view the user's upcoming events, the number of tickets sold for the upcoming event, and one or more analytics associated with the upcoming event (e.g. fan user information and other social media engagement statistics). Event management 228 enables fan users to view the user's upcoming events and pre-event content and media associated with the event. Event management 228 also delivers one or more reminders and pre-event content to keep the fan user engaged and build anticipation for the event. Routine 200 continues by executing the event 226 via a web or mobile interface operably engaged with a video server to enable real-time, two-way video interaction between the celebrity user and the fan users that are participating in the event. Before or upon execution of the event, routine 200 processes a payment 234 from fan users participating in the event, and distributes the funds between the celebrity user broadcasting event and the event management platform.

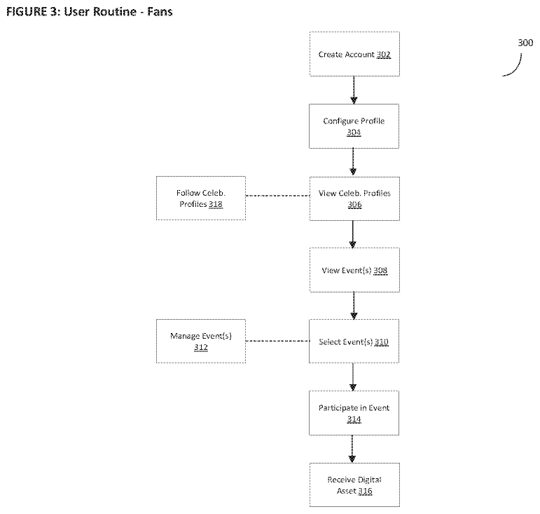

Referring now to FIG. 3, a process flow diagram of a routine 300 for facilitating live online events is shown. According to an embodiment of the present disclosure, routine 300 facilitates the steps taken by a fan user to participate in live online events. Routine 300 is initiated when the fan user navigates to a URL associated with an account creation form and creates an account 302 within the event management application. The fan user then configures his or her profile 304, including account preferences such as subscription type. Once the fan user has created and account and configured his or her profile, the fan user can view celebrity profiles 306 via a web or mobile interface. The fan user can optionally select the celebrity profiles that the fan user desires to follow 318. The fan user may then view one or more events created by celebrity users 308. Events may be suggested to the fan user based on the preferences configured by the user during profile configuration, or the fan user may browse all events in the event management database via a web or mobile interface. The fan user then selects one or more events in which to participate 310. The user's scheduled events are associated with the user's account and managed via the event management application 312. The event management application provides account management by storing and displaying the user's scheduled events in the user's account page, as well as providing updates and reminders associated with the event via email and mobile push notifications. Upon the scheduled date and time of the event, the user participates in the event by connecting to a video server application via a web or mobile interface 314. The video server may be a third-party server that integrates with the event management application to provide a live video and audio experience, or may be integral to the event management application. The live video and audio may be recorded and stored as a digital asset via the video server or the event management database. The fan user may receive the digital asset through the user's account management page 316, and may download and store the digital asset in local storage or share via social media.

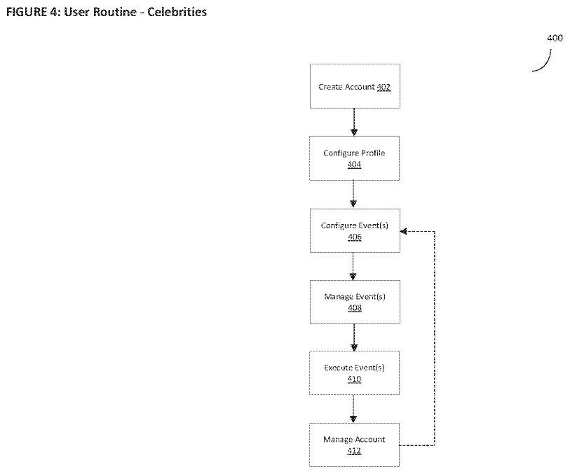

Referring now to FIG. 4, a process flow diagram of a routine 400 for facilitating live online events is shown. According to an embodiment of the present disclosure, routine 400 facilitates the steps taken by a celebrity user to create and facilitate live online events for fans. Routine 400 is initiated when the celebrity user navigates to a URL associated with an account creation form and creates an account 402 within the event management application. The celebrity user then configures his or her profile 404, including profile parameters and digital and/or brand assets associated with the celebrity user. The celebrity user then configures one or more scheduled events associated with the user's account 406; for example, a video group meet and greet, a one-on-one meet and greet, and/or a personalized recorded video message. The celebrity user configures parameters for the event(s) 406, such as event type, date and time, event price, and maximum number of participants. The event is then managed via the event management application 408. The event management application provides event management features in the celebrity user's account, such as schedule reminders and participant data. The event management application may also enable the celebrity user to deliver pre-event content to the participants in order to increase engagement and build anticipation for the event. Upon the scheduled date and time, the celebrity user connects to the video server via a web or mobile interface and executes the event 410. If executing a live event, the celebrity user may interact with fan participants via the video interface and provide dynamic content according to fan feedback. After executing the event, the celebrity user may manage his or her account 412 via an account management interface. The account management interface may enable the celebrity user to view past event information, such as engagement statistics, revenue, and digital assets; as well as configure additional events 406.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks, memory cards or sticks, random access memories (RAMS), read only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment.

Thus, the following claims are hereby incorporated into the Detailed Description, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A system for facilitating live online events comprising:
an event management application server being configured to execute instructions for a user management module, an event management module, and a plurality of application and business logic commands, the user management module operable to dynamically configure a plurality of fan user profiles and a plurality of celebrity user profiles, the event management module being operable dynamically configure a plurality of live online events;
a database operably engaged with the event management application, the database being operable to store a plurality of event management and user management attributes;
a video server operably engaged with the event management application;
at least one celebrity client device operable to communicate one or more inputs to the event management application and broadcast a live online event; and, at least one fan client device operable to communicate one or more inputs to the event management application and view the live online event via a web or mobile browser.
